(19) United States
(12) Patent Application Publication
(10) Pub. No.: US 2008/0053251 A1
(43) Pub. Date: Mar. 6, 2008

(54) Solid Waste Screening System

(76) Inventors: Eugene J. Wingerter, Bethesda, MD (US); William J. Schild, Wilmington, NC (US); Ralph J. Spohn, Williamsburg, VA (US); Steven P. Kadner, Albuquerque, NM (US); Chris Martinez, Albuquerque, NM (US); Stephen McNulty, Albuquerque, NM (US); Natacha Peter, Albuquerque, NM (US)

Correspondence Address: Carstens & Cahoon, LLP, PO Box 802334, Dallas, TX, 75380, US

(21) Appl. No.: 11/469,167

(22) Filed: Aug. 31, 2006

(51) Int. Cl. G01N 1/26

(52) U.S. Cl. 73/863.82

(57) ABSTRACT

The present invention is directed towards a system and method for detecting controlled substances, including without limitation, explosives, chemical agents, drugs, narcotics, and their precursors or byproducts before such substances are used on the general population. Specifically, the present invention is a system and method of analyzing municipal solid waste, or refuse, for the presence of controlled substances.

### BACKGROUND OF THE INVENTION

This invention relates to systems and methods for the detection of controlled substances such as explosives, chemical agents, drugs, narcotics, other hazardous or illegal materials, and the precursors or byproducts of their manufacture. More particularly, the present invention relates to an integrated suite of analyzers networked together and arranged in such a way as to detect the presence of vapors and particulates associated with controlled substances and their precursors in a continuous and non-invasive manner.

The methods and systems for detecting controlled substances have been developed over many years and are ever increasing in their capacity to identify such substances. The specific methods typically employed include trained dogs, x-ray detectors, gamma ray detectors, neutron activation detectors, nuclear magnetic resonance detectors, and highly sophisticated vapor or particulate detection devices. The prior art controlled substance detection methods and systems are deployed in areas where high visibility and/or vulnerability exists, such as in airports. One drawback of this approach to detection, and ultimately deterrence, is that the screening process happens so close to the place where the bad act is carried out that it may already be too late. Ideally, the controlled substance will be discovered by law enforcement personnel or other interested persons long before the potential perpetrator is in a position to do any harm. A need exists, therefore, for a system and method for aiding law enforcement personnel and other interested persons in identifying controlled substances before such substances are ready to be used against the population.

### SUMMARY OF THE INVENTION

The present invention is thus directed towards a method and system for discovering controlled substances, such as explosives, chemical agents, drugs, narcotics, and their precursors or byproducts by detecting their vapor emissions or the particulates associated with these materials early in the process of making such substances. This is accomplished by analyzing the locally collected municipal solid waste for such substances.

Specifically, a terrorist or drug manufacturer generates some waste, which gets discarded in a trash pick up container and placed for disposal. Such refuse is typically collected by municipal or commercial waste management workers and deposited at a transfer station where it is commingled with other solid waste and then trucked to a landfill or other disposal site. Instead of being commingled, the refuse is screened for controlled substances by the present invention. The present invention can be practiced either at a fixed location, such as a solid waste transfer station. It can also be practiced inside a mobile unit, such as the cargo hold of a semi truck which could also be located at such a transfer station. In either case, the refuse to be analyzed is first placed at one end of an object conveyor, such as a conveyor belt. The refuse on the conveyor belt is then spread out into a layer of approximate uniform thickness. The present invention also preferably incorporates a cutting means (rotating blades, for example) adapted to cut open any bags of garbage present so the contents of every bag can be analyzed. The layer of refuse is then analyzed for controlled substances using at least one commercially available analyzer.

The analyzers continuously or semi-continuously monitor air samples taken from just above the refuse layer. The air samples fed to the analyzers are collected using tubes that drag across the top of the moving layer of refuse. Preferably, a series of tubes arc set up next to each other to collect air samples from several different points across the entire width of the refuse layer. The tubes optionally incorporate filters at their openings to guard against large particles being drawn into the analyzers. The air flows through the tubes and into an air collector, which has one connection for each different type of analyzer used with the system. If one or more analyzers detect the presence of a controlled substance, it sends an alarm signal through the system and the portion of refuse that caused the alarm signal is identified for further analysis. Preferably, the refuse is identified by marking it with an ink gun. The suspect refuse can also preferably be scooped or dragged off to the side of the conveyor belt. The identified suspect refuse is subsequently analyzed in detail by interested persons, law enforcement or other official personnel in order to identify the specific substances present. If it is confirmed that controlled substances are present in the suspect refuse, the persons living along the route traveled by the particular waste collection truck can be investigated for possible ties to terrorism, drug or other related offenses.

### BRIEF DESCRIPTION OF THE DRAWINGS

A more complete understanding of the method of the present invention may be had by reference to the following detailed description when taken in conjunction with the accompanying drawings, wherein:

FIG. 1 is an angled overhead view of the first preferred embodiment of the present invention;

FIG. 2 is an angled overhead view of the second preferred embodiment of the present invention;

FIG. 3 is a close up side view of the air sampling tubes of the present invention;

FIG. 4 is a flowchart for the present invention;

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

The present invention is directed towards a system and method for detecting controlled substances, including without limitation, explosives, chemical agents, drugs, narcotics, and their precursors before such substances are used on the general population. Specifically, the present invention is a system and method of analyzing municipal solid waste, or refuse, for the presence of controlled substances.

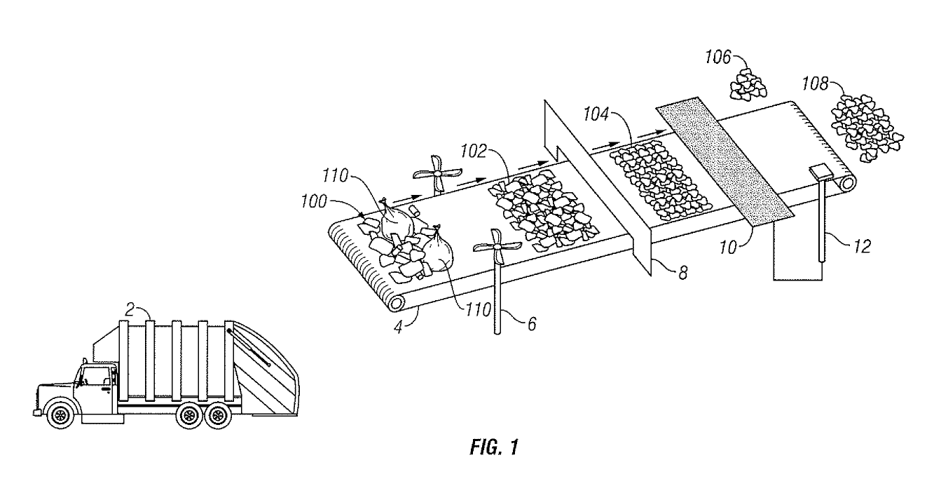

Referring initially to FIG. 1, therein is depicted the various components of the preferred embodiment of the present invention. A waste collection truck 2 deposits its load of refuse 100 at a refuse analysis site, such as a solid waste transfer station. At the refuse analysis site, the refuse 100 is placed on the first end of an object conveyor 4, such as a conveyor belt. The refuse pile 100 will typically include refuse enclosed in bags 110 made out of plastic or similar material. In order for the refuse inside the bags 110 to be accurately analyzed by the present invention, it is optional but preferable to cut the bags 110 open and expose their contents before analysis. To that end, a cutting means 6 is provided along the object conveyor 4. The cutting means, as used herein, includes for example, rotating blades, rotating strings, and the like. The pile of refuse 102 also passes through a spreading means 8. Although FIG. 1 depicts the cutting means situated closer to the first end of the object conveyor than the spreading means, the present invention also contemplates the spreading means being located closer to the first end of the object conveyor than the cutting means. As used herein, the spreading means 8 is preferably a rigid plate defining an opening above the object conveyor 4 situated such that the refuse 102 is spread out into a layer of approximate uniform thickness 104. Alternatively, other means can be used to achieve a relatively uniformly thick refuse layer. The preferable thickness of the refuse layer 104 is between approximately 1 foot and 2 feet, but can range from approximately 0.5 feet to approximately 4 feet in thickness. The uniform layer of refuse 104 is then analyzed for controlled substances by the analyzer 10.

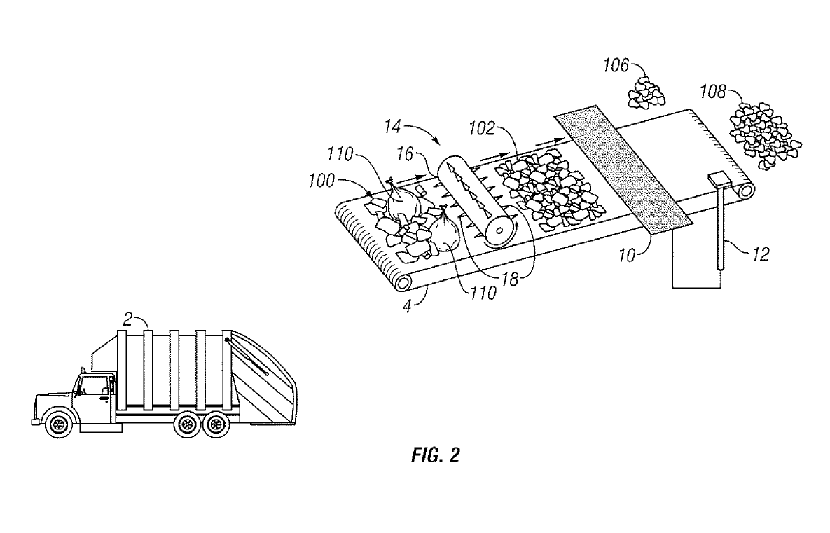

Referring next to FIG. 2, therein is depicted a second preferred embodiment of the present invention. In the second preferred embodiment, the spreading means and the cutting means are combined into a leveling means 14. As used herein, the leveling means 14 is preferably a cylinder 16 with a piercing means 18, such as a multitude of spikes, protruding from its surface. The cylinder 16 is rotably mounted above the object conveyor 4, with the distance between the cylinder surface 16 and the object conveyor 4 being the desired thickness of the refuse layer. A motor (not shown) rotates the surface of the cylinder 16 at approximately the same linear velocity as the surface of the object conveyor 4. The spikes 18 protruding from the surface of the cylinder penetrate bags and other enclosed objects on the object conveyor 4, allowing the analyzer 10 to detect any vapors present inside.

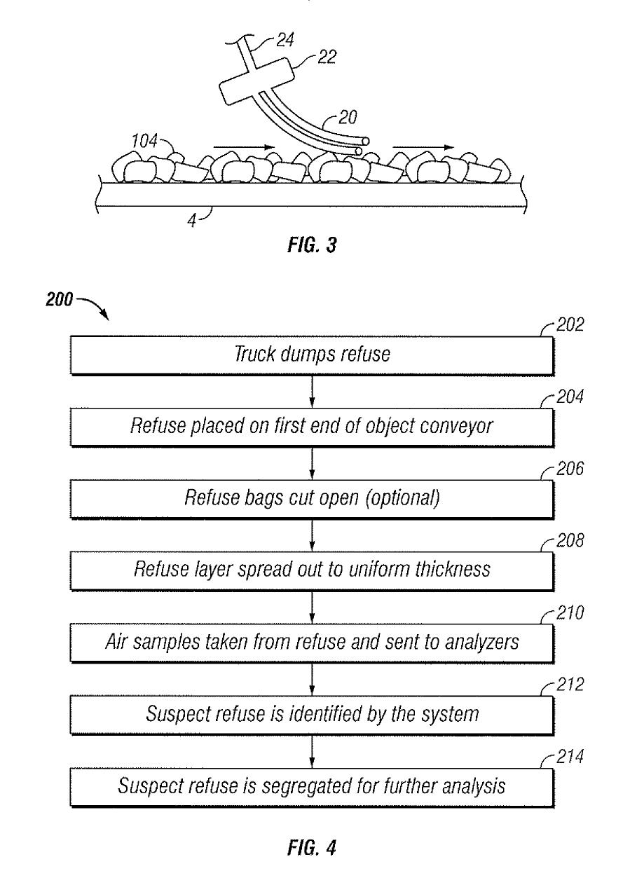

Referring next to FIGS. 1 and 2, as used herein, the analyzer 10 is comprised of at least one detection device (not shown) adapted to detecting controlled substances and its operation will be described in more detail in reference to FIG. 3. The particular type of controlled substance detection device(s) used depends on the specific needs of law enforcement personnel or other interested persons. Interested persons include all persons, whether employees of governmental agencies or not, that are interested in analyzing solid waste for the presence of controlled substances. Also, as controlled substance detection technology progresses, new detection devices can be added to the analyzer or exchanged for older detection devices already in use. When the analyzer 10 detects the presence of a controlled substance, it sends an alarm signal to an object identifier 12 to identify the suspect refuse. As used herein, the object identifier 12 is preferably an ink gun that marks the suspect refuse 106 with an ink or dye that allows law enforcement personnel or other interested persons to segregate the suspect refuse 106 from the non-suspect refuse 108 for further analysis. The object identifier 12 is also preferably a scoop that scoops or drags the suspect refuse 106 off of the object conveyor 4, thereby segregating it from the non-suspect refuse 108 for further analysis. If law enforcement personnel or other interested persons confirm the presence of controlled substances, the homes and businesses along the route taken by the truck that deposited the refuse may be investigated for ties to terrorism or drug related offenses. Data from the analyzer 10 can also be recorded over time and checked for abnormal patterns suggesting illegal activity.

Referring next to FIG. 3, therein is depicted a close up view of the inside of the analyzer 10. The analyzer has an air sampling means comprising at least one flexible tube 20 hanging down above the uniform layer of refuse 104, disposed to drag along the top surface of the refuse 104 as the refuse travels along the object conveyor 4. In order to accurately analyze the refuse 104, the object conveyor 4 preferably moves the refuse 104 at a linear speed of 0.5 feet per second, but can range from 0.1 feet per second to 10 feet per second. The air sampling means, as uses herein, is preferably a series of tubes hangingly disposed above the object conveyor 4 and arranged approximately side by side along the width of the object conveyor 4. The air samples collected from each tube 20 are combined in a collection chamber 22 and then sent to at least one controlled substance detection device (not shown). The detection devices are preferably separated from the refuse layer 104 by approximately two feet to approximately four feet of tubing, but can be as close as six inches or as far as ten feet away from the refuse layer 104. Also, a separate vacuum pump (not shown) can optionally be used to move the air samples from the inlet of the tube 20, through the collection chamber 22, and into the detection device(s). The flowrate of air through the tubes is variable and is determined by the specifications of the particular detection device(s) used in the analyzer.

Referring next to FIG. 4, therein is a flowchart 200 representing the method of analyzing municipal solid waste for controlled substances. First, the waste collection truck deposits a load of refuse at a refuse depository or waste transfer station equipped with the controlled detection equipment of the present invention 202. The refuse is then placed on the first end of an object conveyor 204. Any bags containing refuse are cut open by a cutting means 206. The refuse layer is also spread out into a layer of approximate uniform thickness 208. It is understood that the cutting step 206 is optional and can take place before, after or concurrently with the spreading step 208. Next, air samples taken from the top surface of the refuse are sent to controlled substance detectors 210. The analyzers identify refuse that is suspected of containing controlled substances 212. The suspect refuse is then segregated from the non-suspect refuse for further analysis 214. Data from the analyzer can optionally be collected and statistically charted in order to detect the presence of or trends in possible illegal activity.

The terms “cutting means”, “spreading means”, “object identifier”, “leveling means”, “analyzer”, and “air sampling means” as used herein are intended to have the same definition in the specification and the claims.

We claim:

1. An apparatus for detecting controlled substances comprising:
(a) an object conveyor adapted to transfer objects from a first end of the object conveyor to a second end of the object conveyor;
(b) at least one air sampling means disposed above the object conveyor adapted to sample across the objects on the object conveyor;
(c) at least one analyzer connected to the air sampling means; and
(d) an object identifier for marking objects flagged by the at least one analyzer.

2. The apparatus of claim 1 additionally comprising at least one cutting means adapted to opening objects on the object conveyor.

3. The apparatus of claim 1 additionally comprising an air collector connected to the at least one air sampling means.

4. The apparatus of claim 1 additionally comprising a vacuum pump adapted to moving air samples from the at least one air sampling means to the at least one analyzer.

5. The apparatus of claim 1 additionally comprising at least one spreading means adapted to provide a pile of objects of approximate uniform thickness on the object conveyor.

6. The apparatus of claim 1 additionally comprising a leveling means adapted to approximately uniformly level and pierce objects on the object conveyor.

7. The apparatus of claim 1 wherein the at least one air sampling means comprises a series of flexible tubes affixed to strips of heavy material.

8. The apparatus of claim 1 wherein the at least one air sampling means comprises at least one flexible tube.

9. The apparatus of claim 2 wherein the at least one cutting means comprises at least one blade rotably mounted adjacent to the object conveyor.

10. The apparatus of claim 2 wherein the at least one cutting means comprises at least one string rotably mounted adjacent to the object conveyor.

11. The apparatus of claim 5 wherein the at least one spreading means comprises a rigid plate disposed a predetermined height above the object conveyor.

12. The apparatus of claim 1 wherein the at least one analyzer is one or any combination of analyzers chosen from the group consisting of hydrocarbon detector, PID Passport, Ppb Rae, TMX 412, weapons of mass destruction detectors, PROENGIN AP2C, explosive detectors, gas chromatograph, and mass spectrometer.

13. The apparatus of claim 1 wherein the object identifier comprises an ink gun adapted to mark objects flagged by the at least one analyzer.

14. The apparatus of claim 1 wherein the object identifier comprises a scoop adapted to forcing objects flagged by the at least one analyzer off of the object conveyor before the objects flagged by the at least one analyzer reach the second end of the object conveyor.

15. The apparatus of claim 6 wherein the leveling means comprises a cylinder rotably mounted a predetermined height above the object conveyor, with the cylinder having a central axis approximately parallel to the object conveyor and a multitude of spikes protruding from its surface.

16. A method for detecting controlled substances, comprising the steps of:
(a) conveying refuse or bags of refuse from a first end of a conveyor towards a second end of the conveyor;
(b) sampling air from the refuse layer;
(c) analyzing the air samples using at least one detection device; and
(d) identifying refuse suspected of containing controlled substances.

17. The method of claim 16 comprising the additional step of statistically analyzing data obtained over time from said detection devices for abnormal patterns that indicate illegal activities.

18. The method of claim 16 comprising the additional step of exposing the contents of bags of refuse by opening the bags.

19. The method of claim 16 comprising the additional step of spreading the refuse into a layer of approximate uniform thickness.

20. The method of claim 16 comprising the additional step of marking the refuse suspected of containing controlled substances.
